(19) United States
(12) Patent Application Publication
(10) Pub. No.: US 2026/0336553 A1
(43) Pub. Date: Oct. 29, 2026

(54) Driver Circuit for Driving a Seat Belt with Electronic Locking Functionality

(71) Applicant: Robert Bosch GmbH, Stuttgart (DE)

(72) Inventor: Xiaofei Qiu, Suzhou (CN)

(21) Appl. No.: 19/529,377

(22) Filed: Feb. 4, 2026

(30) Foreign Application Priority Data
Feb. 11, 2025 (CN) 2025 1014 9907.2

(51) Int. Cl. B60R 21/017; B60R 21/01

(52) U.S. Cl. CPC B60R 21/017; B60R 2021/01143; B60R 2021/01184; B60R 2021/01265

(57) ABSTRACT

A driver circuit for driving a seat belt with electronic locking functionality includes (i) a switch driver for receiving a collision signal associated with a vehicle collision for turning on or off the driver circuit, (ii) a current regulator for regulating the drive current flowing through the switch driver to provide drive for the seat belt, and (iii) a safety detection circuit coupled to the switch driver and the seat belt respectively for performing safety detection on the driver circuit. An electronic control unit is also disclosed.

This application claims priority under 35 U.S.C. § 119 to application no. CN 2025 1014 9907.2,filed on Feb. 11, 2025 in China, the disclosure of which is incorporated herein by reference in its entirety.

This application relates to the field of driving seat belts with electronic locking functionality, and more particularly, to a driver circuit for driving seat belts with electronic locking functionality and an electronic control unit (ECU) including the driver circuit.

### BACKGROUND

The zero-gravity seat is a novel car seat design aimed at improving passenger comfort by simulating the weightlessness of space. However, the increased comfort of the zero-gravity seat also poses new safety challenges, especially in effectively protecting passengers during collision events.

### SUMMARY

The inventors of this application recognize that in order to provide comfort while ensuring the safety of occupants, there is a need for a new driver circuit design that can provide a faster and more reliable collision response and ensure timely actuation of seat belts with electronic locking functionality on multiple levels so as to fasten the driver and passengers fast enough to protect them in a collision event.

According to one aspect of this application, a driver circuit is provided for driving a seat belt with electronic locking functionality, the driver circuit comprising: a switch driver for receiving a collision signal associated with a vehicle collision for turning on or off the driver circuit; a current regulator for regulating the drive current flowing through the switch driver to provide drive for the seat belt; and a safety detection circuit coupled to the switch driver and the seat belt respectively for performing safety detection on the driver circuit.

As a supplement or alternative to the above solution, the above driver circuit further comprises: a current regulation monitor for monitoring the drive current.

As a supplement or alternative to the above solution, in the above driver circuit, the seat belt with electronic locking functionality comprises an electronic lock relay, the electronic lock relay being driven by the drive current, and the driver circuit further comprises: a freewheeling diode, which is connected in parallel with the electronic lock relay.

As a supplement or alternative to the above solution, in the driver circuit described above, the collision signal comprises: a first drive signal from a microcontroller; and a second drive signal from an application-specific integrated circuit (ASIC), wherein the first drive signal is independent of the second drive signal.

As a supplement or alternative to the above solution, in the above driver circuit, the first drive signal is determined according to a collision detection algorithm in the microcontroller and the second drive signal is determined according to the collision event detection of the application-specific integrated circuit (ASIC).

As a supplement or alternative to the above solution, in the driver circuit described above, the switch driver comprises: a first switching transistor, the gate of the first switching transistor being coupled to the collision signal, the drain of the first switching transistor being coupled to the electronic lock relay, and the source of the first switching transistor being coupled to the current regulator, wherein the drive current is the drain-source current of the first switching transistor.

As a supplement or alternative to the above solution, in the above driver circuit, the current regulator comprises an adjustable resistor, wherein one end of the adjustable resistor is coupled to the source of the first switching transistor and the other end of the adjustable resistor is grounded.

As a supplement or alternative to the above solution, in the driver circuit described above, the current regulation monitor comprises: a first resistor and a second switching transistor, wherein one end of the first resistor is coupled to a power supply, the other end of the first resistor is coupled to the drain of the second switching transistor, the gate of the second switching transistor is coupled to the source of the first switching transistor, and the source of the second switching transistor is grounded, wherein the current regulation monitor is configured to detect the drive current based on the drain voltage of the second switching transistor in order to prevent the drive current from being too low.

As a supplement or alternative to the above solution, in the driver circuit described above, the safety detection circuit comprises: a second resistor, a third resistor, a fourth resistor, and a first capacitor, wherein one end of the second resistor is coupled to the drain of the first switching transistor, the other end of the second resistor is coupled to one end of the third resistor, the other end of the third resistor is grounded, one end of the fourth resistor is coupled to the other end of the second resistor, the other end of the fourth resistor is coupled to one end of the first capacitor, and the other end of the first capacitor is grounded, and wherein the safety detection circuit is configured to perform safety detection based on the voltage across the first capacitor.

As a supplement or alternative to the above solution, in the driver circuit described above, the safety detection comprises: ground short circuit detection, battery short circuit detection, and open circuit detection, wherein, when the voltage across the first capacitor is less than a preset first threshold related to the influence of ground drift, it is determined that there is a ground short circuit or open circuit; when the voltage across the first capacitor is greater than a preset second threshold related to other power supply voltages, it is determined that there is a battery short circuit.

According to another aspect of the present application, an electronic control unit (ECU) is provided, the electronic control unit (ECU) comprising the driver circuit as previously described.

As a supplement or alternative to the above solution, in the above electronic control unit (ECU), the electronic control unit (ECU) is an airbag ECU for airbag control.

The driver circuit design of the examples of the present application provides a composite collision detection mechanism by combining independent collision signals from a microcontroller and an application-specific integrated ASIC (ASIC), ensuring that the electronic locking function of the seat belt can be triggered more reliably in the event of a collision. Furthermore, the independent signal design allows the system to respond quickly when a collision is detected, improving the speed at which the seat belt locks.

In one or more examples, the introduction of a current regulator and a current regulation monitor in the driver circuit design ensures that the drive current flowing through the switch driver remains within a safe and effective range while preventing the drive current from being too low, thereby ensuring the stable operation of the electronic lock relay. Moreover, the inclusion of a safety detection circuit in the driver circuit enables the entire driver circuit to perform ground short circuit, battery short circuit, and open circuit detection, further increasing the safety and reliability of the circuit.

In one or more examples, a freewheeling diode connected in parallel with the electronic lock relay provides protection for circuit elements (e.g., switching elements) in the driver circuit, preventing voltage spikes caused by inductive loads from damaging the relevant circuit elements. In addition, the adjustable resistor in the current regulator allows for fine-tuning of the drive current to adapt to different operating conditions and requirements.

### BRIEF DESCRIPTION OF THE DRAWINGS

The foregoing and other objectives and advantages of the present application will become more fully apparent from the following detailed description taken in conjunction with the accompanying drawings, in which identical or similar elements are denoted by the same reference numerals.

FIG. 1 shows a block schematic diagram of a driver circuit according to one example of the present application;

FIG. 2 shows a schematic diagram of driving a seat belt with electronic locking functionality according to one example of the present application;

FIG. 3 shows a schematic diagram of the specific circuit design of the driver circuit according to one example of the present application; and

FIG. 4 shows a schematic diagram of a simplified connection between an airbag ECU and a zero-gravity seat according to one example of the present application.

### DETAILED DESCRIPTION

In the following, a driver circuit solution for driving a seat belt with electronic locking functionality according to various exemplary examples of the present application will be described in detail with reference to the accompanying drawings.

In the description of the present specification, references to the terms “one example,” “some examples,” “example,” “specific example,” “some examples,” etc., refer to a specific feature, structure, material, or characteristic described in connection with that embodiment or example that is included in at least one embodiment or example of the examples of the present application. In the present specification, the illustrative expressions of the terms used above are not necessarily directed at the same embodiments or examples. Furthermore, the specific features, structures, materials, or characteristics described may be combined in a suitable manner in any one or more embodiments or examples. Additionally, the terms “first,” “second,” and “third” are used for descriptive purposes only and should not be construed as indicating or implying relative importance. In addition, as long as they do not contradict, those skilled in the art can combine and integrate the different embodiments or examples described in the present specification, as well as the features of the different embodiments or examples.

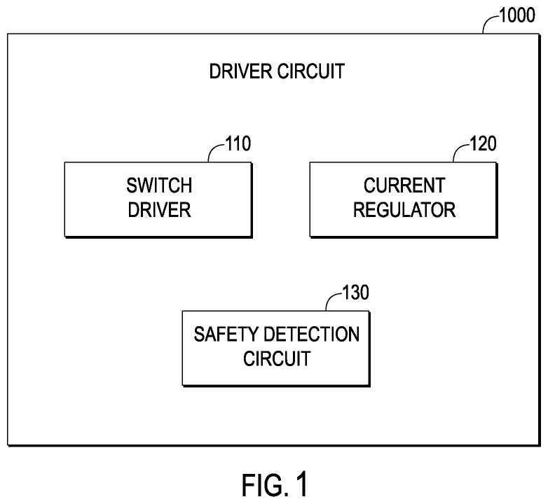

FIG. 1 shows a block schematic diagram of a driver circuit 1000 according to one example of the present application. This driver circuit 1000 is used to drive a seat belt with electronic locking functionality (not shown in FIG. 1). As shown in FIG. 1, the driver circuit 1000 comprises: a switch driver 110 for receiving a collision signal associated with a vehicle collision for turning on or off the driver circuit 1000; a current regulator 120 for regulating the drive current flowing through the switch driver 110 to provide drive for the seat belt; and a safety detection circuit 130 coupled to the switch driver 110 and the seat belt respectively for performing safety detection on the driver circuit 1000.

In the context of the present application, “electronic locking functionality” refers to the ability of a seat belt to automatically lock quickly when a vehicle collision is detected to prevent passengers from being thrust forward during the collision by inertia, thereby reducing the risk of injury. This functionality enables fast locking of the seat belt by controlling the actuator (e.g., an electronic lock relay) in the seat belt.

In FIG. 1, the switch driver 110 receives a collision signal associated with a vehicle collision. These signals may be from a microcontroller, an application-specific integrated circuit (ASIC), or other collision sensors. Based on the received collision signal, the switch driver 110 is responsible for turning on or off the entire driver circuit 1000, thereby activating or deactivating the electronic locking functionality of the seat belt.

In one example, the collision signal comprises: a first drive signal from a microcontroller; and a second drive signal from an application-specific integrated circuit (ASIC), wherein the first drive signal is independent of the second drive signal. For example, the first drive signal may be determined according to a collision detection algorithm in the microcontroller and the second drive signal may be determined according to the collision event detection of an application-specific integrated circuit (ASIC).

In the above example, the first drive signal is from a microcontroller (responsible for running complex collision detection algorithms). These algorithms may consider a variety of sensor inputs, such as accelerometers, speed sensors, pressure sensors, etc., to comprehensively assess the collision risk of the vehicle. The second drive signal is from an application-specific integrated circuit (ASIC). The application-specific integrated circuit (ASIC) may be specifically designed for fast detection of collision events. The collision event detection of the ASIC may be implemented based on specific hardware, such as an analog front-end (AFE) or other high-speed signal processing circuit, to achieve a rapid response to collision signals. Independent collision signal sources reduce the likelihood of false positives. Moreover, the high-speed processing capabilities of ASICs can provide rapid collision detection, which is crucial for safety functions that require immediate response.

The current regulator 120 adjusts the current flowing through the switch driver 110 to ensure that the seat belt obtains sufficient drive force to lock when needed. In addition, by limiting the magnitude of the current, the current regulator 120 helps prevent circuit elements from being damaged by overcurrent, thereby improving the reliability and lifespan of the entire system. Moreover, proper current regulation can avoid unnecessary energy waste and improve the energy efficiency of the system.

The safety detection circuit 130 is capable of detecting and identifying potential faults in the driver circuit 1000, such as ground short circuit, battery short circuit, open circuit, etc. In this way, the safety detection circuit 130 ensures the reliability of the driver circuit 1000 and reduces the risk of seat belt failure due to circuit faults.

Although not shown in FIG. 1, in one example, the driver circuit 1000 described above may further comprise: a current regulation monitor for monitoring the drive current. By detecting the drive current, the current regulation monitor prevents the seat belt's electronic locking functionality from failing due to low current. For example, when an abnormal current level is detected, the current regulation monitor may provide troubleshooting information to assist in identifying and resolving problems.

In one example, the seat belt with electronic locking functionality comprises an electronic lock relay, which is driven by a drive current. That is, the electronic lock relay controls the locking and unlocking of the seat belt by a drive current. When controlled by the drive current, the electronic lock relay can act quickly to lock the seat belt to protect the passenger. Electronic lock relays can respond faster than traditional mechanical locks, increasing protection in the event of a collision.

In further examples, the driver circuit 1000 may further comprise: a freewheeling diode, which is connected in parallel with the seat belt (which contains the electronic lock relay). In this example, the freewheeling diode provides a current path, allowing current to continue flowing, thereby reducing voltage spikes and protecting relevant circuit elements in the driver circuit 1000 (especially the switch driver 110) from damage. Moreover, by reducing voltage spikes, the freewheeling diode helps improve the stability and reliability of the entire driver circuit.

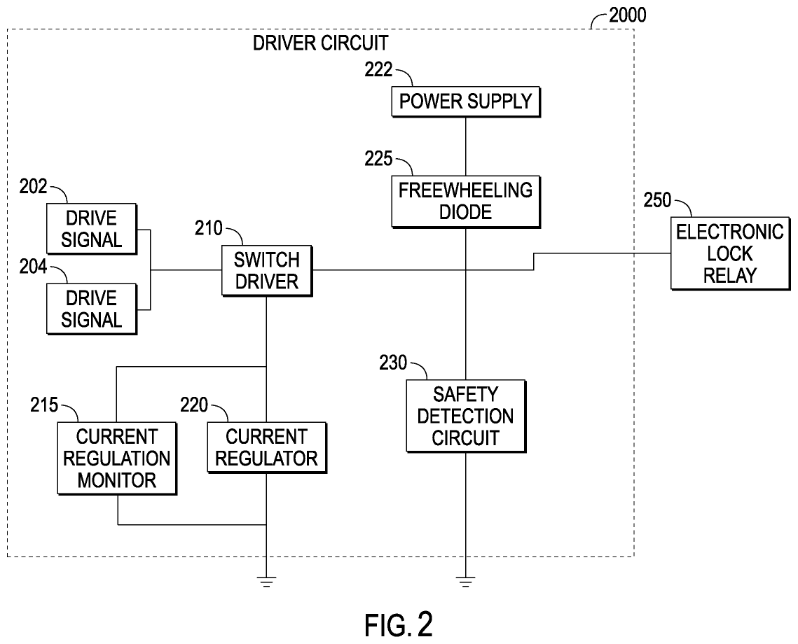

FIG. 2 shows a schematic diagram of driving a seat belt with electronic locking functionality according to one example of the present application. As shown in FIG. 2, the driver circuit 2000 comprises a switch driver 210, the switch driver 210 receiving a drive signal 202 and a drive signal 204, wherein the drive signal 202 is from a microcontroller (e.g., to judge whether there is a collision through an algorithm) and the drive signal 204 is from an application-specific integrated circuit (ASIC) chip (e.g., determined through collision event detection).

In the example of FIG. 2, the electronic locking functionality of the seat belt is achieved by an electronic lock relay 250, the electronic lock relay 250 being controlled by a switch driver 210. The switch driver 210 is turned on or off by two independent signals 202 and 204, these two signals coming from the microcontroller (uC) and the application-specific integrated circuit (ASIC), respectively. The drive signal 202 in the microcontroller is generated based on a collision detection algorithm. This algorithm analyzes various sensor data of the vehicle, such as acceleration, speed changes, etc., to determine whether a collision has occurred. If the algorithm detects a collision, it sends a signal to activate the switch driver 210. The drive signal 204 in the ASIC is generated based on its built-in collision event detection mechanism. The ASIC may include specialized hardware to quickly identify collision events and send a signal immediately upon detection of a collision to activate the switch driver 210. By providing two independent drive signals from the microcontroller and ASIC, the control of the switch driver 210 is made safer and more reliable.

The driver circuit 2000 further comprises: a current regulator 220, a current regulation monitor 215, a power supply 222, a freewheeling diode 225, and a safety detection circuit 230. Wherein, the current regulator 220 is used to adjust the drive current flowing through the switch driver 210 to provide the electronic lock relay 250 for drive; the current regulation monitor 215 is used to monitor the drive current flowing through the switch driver 210; and the freewheeling diode 225 is coupled between the power supply 222 and the safety detection circuit 230. The safety detection circuit 230 is coupled to the switch driver 210 and the electronic lock relay 250, respectively, for safety detection of the driver circuit 2000.

In one example, the safety detection circuit 230 is used to detect faults such as short to battery, short to GND, and open fault. For example, the safety detection circuit 230 can achieve these detections by monitoring the voltages of critical nodes.

In one or more examples, if the drive current is below the specified specification, the current regulation monitor 215 is also able to detect this. This ensures that the electronic lock relay 250 receives an appropriate drive current to effectively lock the seat belt when needed.

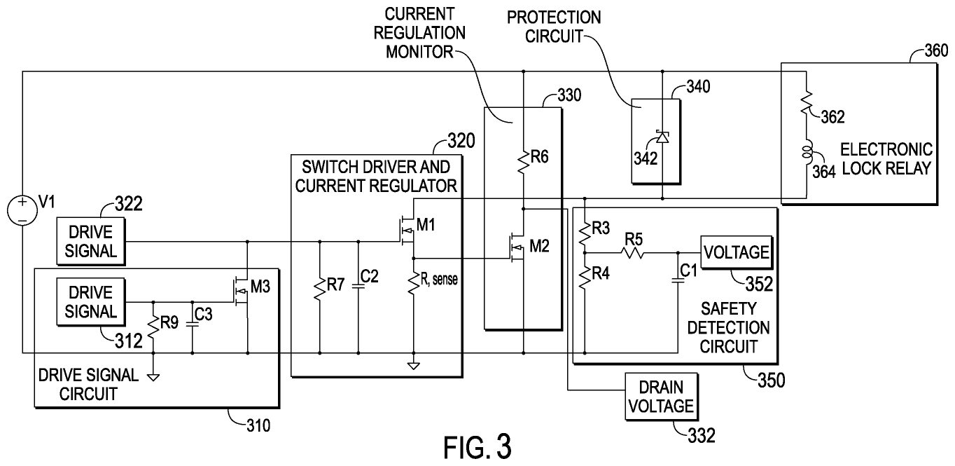

FIG. 3 shows a schematic diagram of the specific circuit design of the driver circuit according to one example of the present application. In FIG. 3, block 320 shows the switch driver and the current regulator. Wherein, the switch driver comprises a first switching transistor M1, the gate of the first switching transistor M1 is coupled to a collision signal (e.g., a drive signal 322 from a microcontroller), the drain of the first switching transistor M1 is coupled to an electronic lock relay 360, and the source of the first switching transistor M1 is coupled to one end of an adjustable resistor R_sense of the current regulator, the other end of the adjustable resistor R_sense being grounded. By adjusting the resistance of the adjustable resistor R_sense, the drain-source current of the first switching transistor M1 may also be adaptively adjusted. In addition to the adjustable resistor R_sense, the current regulator may further comprise a resistor R7 and a capacitor C2. One end of the resistor R7 and the capacitor C2 is coupled to the gate of the first switching transistor M1 and the other end is grounded.

It can be seen from FIG. 3 that the first switching transistor M1 is controlled by two drive signals: (1) the drive signal 322 from the microcontroller; and (2) the output from a drive signal circuit 310 of an application-specific integrated circuit (ASIC) chip. Referring to FIG. 3, the drive signal circuit 310 comprises a switching transistor M3, a resistor R9, and a capacitor C3. When the drive signal 312 from the application-specific integrated circuit (ASIC) chip is high, the switching transistor M3 will be in the on state, and the gate of the first switching transistor M1 is also pulled low and cannot be turned on (regardless of whether the drive signal 322 from the microcontroller is high or low). On the one hand, the first switching transistor M1 is controlled by two independent signal sources, namely the drive signal 322 of the microcontroller and the drive signal 312 of the ASIC, which provides redundant control and increases the reliability of the system; on the other hand, in some cases, the microcontroller may issue the wrong drive signal due to software errors or external interference. The ASIC's high-priority signals can prevent these erroneous signals from unintentionally causing the first switching transistor M1 to turn on, thereby avoiding potential safety risks.

With continued reference to FIG. 3, the current regulation monitor 330 comprises: a first resistor R6 and a second switching transistor M2, wherein one end of the first resistor R6 is coupled to the positive terminal of a power supply V1, the other end of the first resistor R6 is coupled to the drain of the second switching transistor M2, the gate of the second switching transistor M2 is coupled to the source of the first switching transistor M1, and the source of the second switching transistor M2 is grounded. In this way, the current regulation monitor 330 can be configured to detect the drive current flowing through the first switching transistor M1 based on the drain voltage of the second switching transistor M2 in order to prevent the drive current from being too low. For example, assuming that there is no situation where the drive current is too low (e.g., the drive signal 322 from the microcontroller is high), the first switching transistor M1 is turned on, and then the second switching transistor M2, such that the drain voltage 332 of the second switching transistor M2 is low. However, if the drive current is insufficient (e.g., due to a fault of the first switching transistor M1), the second switching transistor M2 will not be able to be turned on, and the drain voltage 332 of the second switching transistor M2 remains high. Thus, the drain voltage 332 of the second switching transistor M2 can be used to determine whether the drive current is too low.

In FIG. 3, the safety detection circuit 350 comprises: a second resistor R3, a third resistor R4, a fourth resistor R5, and a first capacitor C1, wherein one end of the second resistor R3 is coupled to the drain of the first switching transistor M1, the other end of the second resistor R3 is coupled to one end of the third resistor R4, and the other end of the third resistor R4 is grounded. One end of the fourth resistor R5 is coupled to the other end of the second resistor R3, the other end of the fourth resistor R5 is coupled to one end of the first capacitor C1, and the other end of the first capacitor C1 is grounded. In this safety detection circuit 350, safety detection may be performed based on the voltage 352 across the first capacitor C1.

In one or more examples, the safety detection comprises: ground short circuit detection, battery short circuit detection, and open circuit detection. For example, when the voltage 352 across the first capacitor C1 is less than a preset first threshold (e.g., 0.5V) associated with the ground drift effect, a ground short circuit is judged to be present; and when the voltage 352 across the first capacitor C1 is greater than a preset second threshold (e.g., 6-7V) associated with other power supply voltages, a battery short circuit is judged to be present.

Block 340 shows a protection circuit comprising a freewheeling diode 342, the freewheeling diode 342 being connected in parallel with an electronic lock relay 360 (shown schematically in series via a DC resistor 362 and an inductor 364). When the current of an inductive load is suddenly interrupted, a back electromotive force (counter-electromotive force or induced electromotive force) is created, which may damage switching elements (such as MOSFETs, IGBTs or transistors). The presence of the protection circuit 340 (comprising the freewheeling diode 342) provides a path to allow the current to continue to flow, thereby protecting the relevant circuit elements from the effects of high voltage spikes.

In one or more examples, the driver circuit may also be configured to output a PWM (Pulse Width Modulation) signal to the electronic lock relay 360. This can be controlled, e.g., through a microcontroller. The output of the PWM signal may allow precise control of the drive current of the electronic lock relay 360. Moreover, by adjusting the duty cycle of the PWM signal (i.e., the proportion of time the signal is in a high-level state), the average current flowing through the electronic lock relay 360 can be controlled to achieve fine control of the electronic lock relay 360 and reduce energy consumption, as the relay does not need to operate continuously at full power. Finally, the high-frequency characteristics of PWM signals help reduce electromagnetic interference because the fast switching of the current can reduce the rate of current change, thereby reducing electromagnetic radiation.

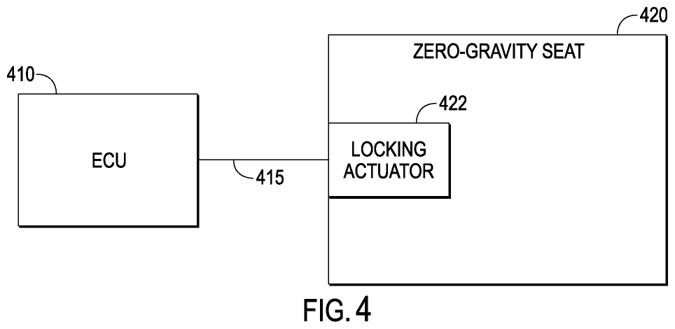

Referring to FIG. 4, it shows a schematic diagram of a simplified connection between an electronic control unit ECU 410 and a zero-gravity seat (or seat belt) 420 according to one example of the present application. In one example, the electronic control unit ECU 410 comprises the driver circuit of one or more examples of the present application. The electronic control unit ECU 410 may be an airbag ECU used for the control of the airbag. In addition, in the event of a collision, the electronic control unit (ECU) 410 sends a control signal (e.g., a PWM signal) 415 to the locking actuator 422 (e.g., an electronic lock relay) of the zero-gravity seat (or seat belt) 420 to ensure that the locking actuator of the seat or seat belt can respond quickly and provide an appropriate locking force. In this way, the overall performance of the vehicle system can be improved, especially in collision events, which can provide better protection for passengers.

In summary, the driver circuit design of the examples of the present application provides a composite collision detection mechanism by combining independent collision signals from a microcontroller and an application-specific integrated ASIC (ASIC), ensuring that the electronic locking function of the seat belt can be triggered more reliably in the event of a collision. Furthermore, the independent signal design allows the system to respond quickly when a collision is detected, improving the speed at which the seat belt locks.

The above examples illustrate, inter alia, the driver circuit solution for driving a seat belt with electronic locking functionality according to examples of the present application. Although only some of the examples of the present application have been described, it should be understood by those with ordinary skill in the art that the present application may be implemented in various other forms without departing from its spirit and scope. Therefore, the examples and embodiments presented are illustrative rather than limiting, and the present application may encompass various modifications and replacements without departing from the spirit and scope defined by the various claims.

What is claimed is:

1. A driver circuit for driving a seat belt with electronic locking functionality, wherein the driver circuit comprises:
a switch driver configured to receive a collision signal associated with a vehicle collision for turning on or off the driver circuit;
a current regulator configured to regulate the drive current flowing through the switch driver to provide drive for the seat belt; and
a safety detection circuit coupled to the switch driver and the seat belt respectively and configured to perform safety detection on the driver circuit.

2. The driver circuit according to claim 1, further comprising:
a current regulation monitor configured to monitor the drive current.

3. The driver circuit according to claim 2, wherein the seat belt with electronic locking functionality comprises an electronic lock relay, the electronic lock relay being driven by the drive current, and the driver circuit further comprises:
a freewheeling diode, which is connected in parallel with the electronic lock relay.

4. The driver circuit according to claim 1, wherein the collision signal comprises:
a first drive signal from a microcontroller; and
a second drive signal from an application-specific integrated circuit,
wherein the first drive signal is independent of the second drive signal.

5. The driver circuit according to claim 4, wherein the first drive signal is determined according to a collision detection algorithm in the microcontroller and the second drive signal is determined according to the collision event detection of the application-specific integrated circuit.

6. The driver circuit according to claim 3, wherein the switch driver comprises:
a first switching transistor, the gate of the first switching transistor being coupled to the collision signal, the drain of the first switching transistor being coupled to the electronic lock relay, and the source of the first switching transistor being coupled to the current regulator, wherein the drive current is the drain-source current of the first switching transistor.

7. The driver circuit according to claim 6, wherein the current regulator comprises an adjustable resistor, wherein one end of the adjustable resistor is coupled to the source of the first switching transistor and the other end of the adjustable resistor is grounded.

8. The driver circuit according to claim 7, wherein the current regulation monitor comprises: a first resistor and a second switching transistor, wherein one end of the first resistor is coupled to a power supply, the other end of the first resistor is coupled to the drain of the second switching transistor, the gate of the second switching transistor is coupled to the source of the first switching transistor, and the source of the second switching transistor is grounded, and
wherein the current regulation monitor is configured to detect the drive current based on the drain voltage of the second switching transistor in order to prevent the drive current from being too low.

9. The driver circuit according to claim 8, wherein:
the safety detection circuit comprises: a second resistor, a third resistor, a fourth resistor, and a first capacitor,
one end of the second resistor is coupled to the drain of the first switching transistor, the other end of the second resistor is coupled to one end of the third resistor, the other end of the third resistor is grounded, one end of the fourth resistor is coupled to the other end of the second resistor, the other end of the fourth resistor is coupled to one end of the first capacitor, and the other end of the first capacitor is grounded, and
the safety detection circuit is configured to perform safety detection based on the voltage across the first capacitor.

10. The driver circuit according to claim 9, wherein:
the safety detection comprises: ground short circuit detection, battery short circuit detection, and open circuit detection,
when the voltage across the first capacitor is less than a preset first threshold associated with the ground drift effect, a ground short circuit is judged to be present, and
when the voltage across the first capacitor is greater than a preset second threshold associated with other power supply voltages, a battery short circuit is judged to be present.

11. An electronic control unit (ECU), wherein the electronic control unit (ECU) comprises the driver circuit according to claim 1.

12. The electronic control unit (ECU) according to claim 11, wherein the electronic control unit (ECU) is an airbag ECU used for airbag control.
